(19) United States
(12) Patent Application Publication
(10) Pub. No.: US 2026/0092517 A1
(43) Pub. Date: Apr. 2, 2026

(54) MONITORING INTEGRITY OF SUBSURFACE ELECTRICAL DEVICES

(71) Applicant: Chevron U.S.A. Inc., San Ramon, CA (US)

(72) Inventors: Xinhui Min, Spring, TX (US); Ivan Lim Chen Ning, Houston, TX (US); Monika Valjak, Mandeville, LA (US)

(21) Appl. No.: 18/903,915

(22) Filed: Oct. 1, 2024

(51) Int. Cl. E21B 47/008; E21B 34/06; E21B 43/12; G08B 21/18

(52) U.S. Cl. CPC E21B 47/008; E21B 34/066; E21B 43/128; G08B 21/182

(57) ABSTRACT

A subsurface electrical device monitoring system includes a controller configured to: obtain measurements made by a first sensor device measuring a temperature adjacent to a subsurface electrical device and a second sensor device measuring a power parameter associated with the subsurface electrical device; correlate the measurements made by the first and second sensor devices by time; generate a baseline of performance of the electrical device over periods of time within which the subsurface electrical device starts; obtain subsequent measurements made by the first sensor device and the second sensor device; correlate the subsequent measurements made by the first and second sensor devices by time; compare the subsequent measurements made by the first sensor device against expected values derived from the baseline; and determine that a problem is developing with the subsurface electrical device when a difference between a subsequent measurement and an expected value exceeds a threshold value.

### TECHNICAL FIELD

The present application is related to subterranean field operations and, more particularly, to monitoring the integrity of subsurface electrical devices.

### BACKGROUND

Certain electrical devices, such as electrical submersible pumps (ESPs), operate in a wellbore at depths of hundreds, thousands, or tens of thousands of feet. When this equipment fails, large amounts of time and expense are incurred to remove the equipment, replace the equipment at the surface, and put the replacement equipment back in place within the wellbore.

### SUMMARY

In general, in one aspect, the disclosure relates to a subsurface electrical device monitoring system. The subsurface electrical device monitoring system includes a first sensor device disposed within a wellbore adjacent to a subsurface electrical device, where the first sensor device is configured to measure a temperature. The subsurface electrical device monitoring system also includes a second sensor device that is configured to measure a power parameter associated with the subsurface electrical device. The subsurface electrical device monitoring system further includes a controller communicably coupled to the first sensor device and the second sensor device. The controller is configured to obtain measurements made by the first sensor device and the second sensor device. The controller is also configured to correlate the measurements made by the first sensor device and the second sensor device by time. The controller is further configured to generate a baseline of performance of the electrical device over periods of time within which the subsurface electrical device starts. The controller is also configured to obtain subsequent measurements made by the first sensor device and the second sensor device. The controller is further configured to correlate the subsequent measurements made by the first sensor device and the second sensor device by time. The controller is also configured to compare the subsequent measurements made by the first sensor device against expected values derived from the baseline. The controller is further configured to determine that a problem is developing with the subsurface electrical device when a difference between one of the subsequent measurements and one of the expected values exceeds a threshold value.

In another aspect, the disclosure relates to a method for monitoring an integrity of a subsurface electrical device. The method includes obtaining, by a controller, measurements made by a first sensor device and a second sensor device, where the first sensor device is disposed within a wellbore adjacent to the subsurface electrical device, where the first sensor device is configured to measure a temperature, and where the second sensor device is configured to measure a power parameter associated with the subsurface electrical device. The method also includes correlating the measurements made by the first sensor device and the second sensor device by time. The method further includes generating a baseline of performance of the electrical device over periods of time within which the subsurface electrical device starts. The method also includes obtaining subsequent measurements made by the first sensor device and the second sensor device. The method further includes correlating the subsequent measurements made by the first sensor device and the second sensor device by time. The method also includes comparing the subsequent measurements made by the first sensor device against expected values derived from the baseline. The method further includes determining that a problem is developing with the subsurface electrical device when a difference between one of the subsequent measurements and one of the expected values exceeds a threshold value.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 shows a sectional view of a field system that includes a monitoring system for subsurface electrical devices according to certain example embodiments.

FIG. 2 shows a block diagram of a computing device according to certain example embodiments.

FIG. 3 shows an example of a general workflow of the subsurface electrical device monitoring system according to certain example embodiments.

FIG. 4 shows part of a tubing string that includes multiple electrical devices whose performance is monitored by a subsurface electrical device monitoring system according to certain example embodiments.

FIGS. 5 through 8 show graphical representations of evaluation of the electrical devices of FIG. 4 by an example subsurface electrical device monitoring system according to certain example embodiments.

FIG. 9 shows a graphical representation of training data generated by the subsurface electrical device monitoring system according to certain example embodiments.

FIG. 10 shows a graphical representation of testing data generated by the subsurface electrical device monitoring system according to certain example embodiments.

FIG. 11 shows a graphical representation of predicting the performance integrity of an electrical device by the subsurface electrical device monitoring system according to certain example embodiments.

FIG. 12 shows a flow diagram of a methodology used by the subsurface electrical device monitoring system according to certain example embodiments.

FIG. 13 shows a flowchart of a method for monitoring the integrity of a subsurface electrical device according to certain example embodiments.

### DESCRIPTION OF THE INVENTION

The example embodiments discussed herein are directed to systems, methods, and devices for monitoring the integrity of subsurface electrical devices. Wellbores for which example embodiments are used can be drilled and completed to extract a subterranean resource. Examples of a subterranean resource can include, but are not limited to, natural gas, oil, and water. Wellbores for which example embodiments are used can be subsea or land-based. Example embodiments can be rated for use in marine and/or hazardous environments. The wellbore for which example embodiments are used can be production wells or injection wells.

Example embodiments can include multiple components that are described herein, where a component can be made from a single piece (as from a mold or an extrusion). When a component (or portion thereof) of an example embodiment for monitoring the integrity of subsurface electrical devices is made from a single piece, the single piece can be cut out, bent, stamped, and/or otherwise shaped to create certain features, elements, or other portions of the component. Alternatively, a component (or portion thereof) of an example embodiment for monitoring the integrity of subsurface electrical devices can be made from multiple pieces that are mechanically coupled to each other. In such a case, the multiple pieces can be mechanically coupled to each other using one or more of a number of coupling methods, including but not limited to adhesives, welding, fastening devices, compression fittings, mating threads, and slotted fittings. One or more pieces that are mechanically coupled to each other can be coupled to each other in one or more of a number of ways, including but not limited to fixedly, hingedly, rotatably, removably, slidably, and threadably.

Components and/or features described herein can include elements that are described as coupling, fastening, securing, or other similar terms. Such terms are merely meant to distinguish various elements and/or features within a component or device and are not meant to limit the capability or function of that particular element and/or feature. For example, a feature described as a “coupling feature” can couple, secure, abut against, fasten, and/or perform other functions aside from merely coupling. In addition, each component and/or feature described herein (including each component of an example subsurface electrical device monitoring system) can be made of one or more of a number of suitable materials, including but not limited to metal (e.g., stainless steel), ceramic, rubber, glass, and plastic.

A coupling feature (including a complementary coupling feature) as described herein can allow one or more components (e.g., a housing) and/or portions of an example embodiment for monitoring the integrity of subsurface electrical devices to become mechanically coupled, directly or indirectly, to another portion of the example embodiment for monitoring the integrity of subsurface electrical devices and/or a component of a larger system. A coupling feature can include, but is not limited to, a portion of mating threads, a hinge, an aperture, a recessed area, a protrusion, a slot, and a detent. One portion of an example system for monitoring the integrity of subsurface electrical devices can be coupled to another portion of the example embodiment of a system for monitoring the integrity of subsurface electrical devices and/or a component of a larger system by the direct use of one or more coupling features.

In addition, or in the alternative, a portion of an example embodiment for monitoring the integrity of subsurface electrical devices can be coupled to another portion of the example embodiment for monitoring the integrity of subsurface electrical devices and/or a component of a larger system using one or more independent devices that interact with one or more coupling features disposed on a component of the example embodiment for monitoring the integrity of subsurface electrical device. Examples of such devices can include, but are not limited to, a fastening device (e.g., a bolt, a screw, a rivet), a pin, a hinge, an adapter, and a spring. One coupling feature described herein can be the same as, or different than, one or more other coupling features described herein. A complementary coupling feature as described herein can be a coupling feature that mechanically couples, directly or indirectly, with another coupling feature.

When used in certain systems (e.g., for certain subterranean field operations), example embodiments can be designed to help such systems comply with certain standards and/or requirements. Examples of entities that set such standards and/or requirements can include, but are not limited to, the Society of Petroleum Engineers, the American Petroleum Institute (API), the International Standards Organization (ISO), and the Occupational Safety and Health Administration (OSHA). Also, as discussed above, example embodiments for monitoring the integrity of subsurface electrical devices can be used in marine and/or hazardous environments, and so example embodiments for monitoring the integrity of subsurface electrical devices can be designed to comply with industry standards that apply to marine and/or hazardous environments.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components.

For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C.

In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C).

In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

If a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three-digit number or a four-digit number, and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments for monitoring the integrity of subsurface electrical devices will be described more fully hereinafter with reference to the accompanying drawings, in which example embodiments for monitoring the integrity of subsurface electrical devices are shown. Example embodiments for monitoring the integrity of subsurface electrical devices may, however, be embodied in many different forms and should not be construed as limited to the example embodiments set forth herein. Rather, these example embodiments are provided so that this disclosure will be thorough and complete, and will fully convey the scope of monitoring the integrity of subsurface electrical devices to those of ordinary skill in the art. Like, but not necessarily the same, elements (also sometimes called components) in the various figures are denoted by like reference numerals for consistency.

Terms such as “first”, “second”, “primary,” “secondary,” “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. This list of terms is not exclusive. Such terms are not meant to denote a preference or a particular orientation, and they are not meant to limit embodiments of monitoring the integrity of subsurface electrical devices. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

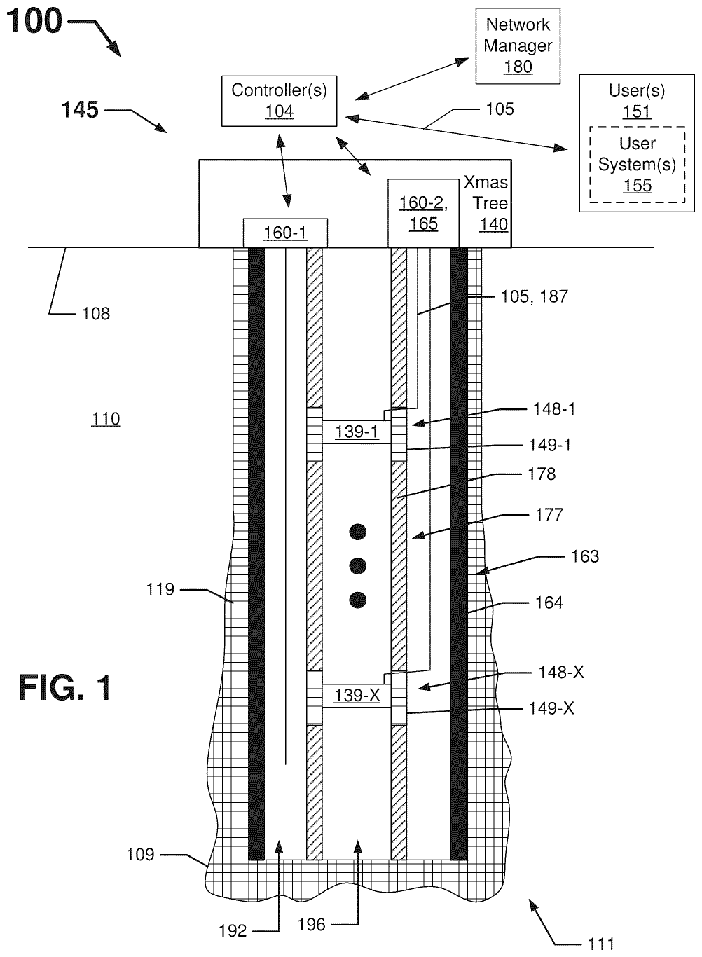

FIG. 1 shows a sectional view of a field system 100 that includes a subsurface electrical device monitoring system 145 according to certain example embodiments. The components shown in FIG. 1 are not exhaustive, and in some embodiments, one or more of the components shown in FIG. 1 may not be included in the example field system 100. Any component of the field system 100 may be discrete or combined with one or more other components of the field system 100. Also, one or more components of the field system 100 may have different configurations. For example, a controller 104 may be combined with a sensor device 160-1 into a single component. As another example, one or more of the sensor devices 160 may be disposed within or disposed on other components (e.g., a valve of the Xmas tree 140, a power source 165) of the field system 100.

The field system 100 of FIG. 1 shows a wellbore 111 drilled into a subterranean formation 110. The wellbore 111 is defined by a wall 109. The wellbore 111 is drilled using a rig (e.g., a derrick, a tool pusher, a clamp, a tong) and field equipment (e.g., drill pipe, casing pipe, a drill bit, a fluid pumping system). Some of this field equipment is located above (e.g., at, near) the ground 108 (e.g., a seabed for subsea operations, dry land for land-based operations), and other parts of the field equipment is located within the wellbore 111 as the wellbore 111 is developed. For example, the field system 100 of FIG. 1 shows a casing string 163 is positioned within the wellbore 111 and set against the wall 109 of the wellbore 111 with cement 119. Specifically, once the wellbore 111 (or a section thereof) is drilled, the casing string 163 is inserted into the wellbore 111 and subsequently cemented to the wall 109 of the wellbore 111 to stabilize the wellbore 111 and allow for the extraction of subterranean resources (e.g., oil, natural gas) from the subterranean formation 110.

The point where the wellbore 111 begins at the ground 108 can be called the entry point. While not shown in FIG. 1, there can be multiple wellbores 111, each with their own entry point but that are located close to the other entry points, drilled into the subterranean formation 110. In such a case, the multiple wellbores 111 can be drilled at the same pad location using the same rig and, in some cases, at least some of the same field equipment. For subsea operations, the ground 108 may be some distance (e.g., hundreds of feet, thousands of feet, miles) below the water line.

The subterranean formation 110 can include one or more of a number of formation types, including but not limited to shale, limestone, sandstone, clay, sand, and salt. In certain embodiments, a subterranean formation 110 can include one or more reservoirs in which one or more subterranean resources (e.g., oil, gas, water, steam) can be located. One or more of a number of field operations (e.g., fracturing, coring, tripping, drilling, cementing casing, injecting, extracting downhole resources) can be performed to reach an objective of a user with respect to the subterranean formation 110.

The wellbore 111 can have one or more of a number of segments, where each segment can have one or more of a number of dimensions. Examples of such dimensions can include, but are not limited to, a size (e.g., diameter) of the wellbore 111, a curvature of the wellbore 111, a true vertical depth of the wellbore 111, a measured depth of the wellbore 111, and a horizontal displacement of the wellbore 111. As in this case, the wellbore 111 can also undergo multiple cementing operations, where each cementing operation covers part or all of a segment of the wellbore 111 or multiple segments of the wellbore 111. A segment of the wellbore 111 may be substantially vertical, substantially horizontal, and/or somewhere in between. A segment of the wellbore 111 may be substantially linear and/or have a curvature.

Each end of a casing pipe 164 has mating threads (a type of coupling feature) disposed thereon, allowing a casing pipe 164 to be mechanically coupled to another casing pipe 164 in an end-to-end configuration. The casing pipes 164 of the casing string 163 can be mechanically coupled to each other directly or indirectly using a coupling device, such as a coupling sleeve. Each casing pipe 164 of the casing string 163 can have a length and a width (e.g., inner diameter, outer diameter). The length of a casing pipe 164 can vary. For example, a common length of a casing pipe 164 is approximately 40 feet. The length of a casing pipe 164 can be longer (e.g., 60 feet) or shorter (e.g., 10 feet) than 40 feet. The width of a casing pipe 164 can also vary and can depend on the cross-sectional shape of the casing pipe 164. For example, when the cross-sectional shape of a casing pipe 164 is circular, which is commonly the case, the width can refer to an outer diameter, an inner diameter, or some other form of measurement of the casing pipe 164. Examples of a width in terms of an outer diameter of a casing pipe 164 can include, but are not limited to, 4-½ inches, 7 inches, 7-⅝ inches, 8-⅝ inches, 10-¾ inches, 13-⅜ inches, and 14 inches. Typically, as in this case, the larger widths of the casing pipe 164 (as for casing string 163) are closer to the entry point at the ground 108, and the width gradually decreases by segment moving toward the distal end of the wellbore 111.

The size (e.g., width, length) of a casing string 163 can be based on the information gathered using field equipment with respect to the subterranean wellbore 111. As discussed above, the walls of the casing pipes 164 of the casing string 163 have an inner surface that form a cavity that traverses the length of the casing string 163. Each casing pipe 164 of the casing string 163 can be made of one or more of a number of suitable materials, including but not limited to stainless steel.

In addition, a tubing string 177 is positioned within the wellbore 111 inside of the casing string 163. The space between the tubing string 177 and the casing string 163 in the wellbore 111 is the annulus 192. The tubing string 177 includes at least one sub 148 (e.g., sub 148-1 through sub 148-X) and a number of tubing pipes 178 that are coupled to each other end-to-end to form the tubing string 177. Each end of a tubing pipe 178 and each end of a sub 148 has mating threads (a type of coupling feature) disposed thereon, allowing a tubing pipe 178 and/or a sub 148 to be mechanically coupled to another tubing pipe 178 and/or another sub 148 in an end-to-end configuration. The one or more subs 148 and the tubing pipes 178 of the tubing string 177 can be mechanically coupled to each other directly or indirectly using a coupling device, such as a coupling sleeve. The tubing string 177 has a cavity 196 along its length.

Each tubing pipe 178 of the tubing string 177 can have a length and a width (e.g., outer diameter). The length of a tubing pipe 178 can vary. For example, a common length of a tubing pipe 178 is approximately 30 feet. The length of a tubing pipe 178 can be longer (e.g., 60 feet) or shorter (e.g., 10 feet) than 30 feet. The width of a tubing pipe 178 can also vary and can depend on the cross-sectional shape of the tubing pipe 178. For example, when the cross-sectional shape of a tubing pipe 178 is circular, which is commonly the case, the width can refer to an outer diameter, an inner diameter, or some other form of measurement of the tubing pipe 178. Examples of a width in terms of an outer diameter of a tubing pipe 178 can include, but are not limited to, 4-½ inches, 7 inches, 7-⅝ inches, 8-⅝ inches, and 10-¾ inches. The outer diameter of the tubing string 177 is less than the inner diameter of the casing string 163 at a given depth along the entirety of the wellbore 111.

A sub 148 includes a body 149 (e.g., body 149-1 for sub 148-1, body 149-X for sub 148-X) and at least one electrical device 139 (e.g., electrical device 139-1 for sub 148-1, electrical device 139-X for sub 148-X). The body 149 of a sub 148 can have a wall that forms a cavity, inside of which is disposed the electrical device 139 of the sub 148. The cavity of the body 149 of a sub 148 coincides with the cavity 196 of the rest of the tubing string 177. An electrical device 139 of a sub 148 operates by receiving power and/or control signals from a power source 165 at or near the ground 108 (e.g., integrated with the Xmas tree 140) via power transfer links 187 and/or communication links 105, respectively. Each communication link 105 may include wired (e.g., Class 1 electrical cables, electrical connectors, Power Line Carrier, RS485) and/or wireless (e.g., sound or pressure waves in a fluid in the annulus 192, Wi-Fi, Zigbee, visible light communication, cellular networking, Bluetooth, Bluetooth Low Energy (BLE), ultrawide band (UWB), WirelessHART, ISA100) technology.

Each power transfer link 187 may include one or more electrical conductors, which may be individual or part of one or more electrical cables. In some cases, as with inductive power, power may be transferred wirelessly using power transfer links 187. A power transfer link 187 may transmit power from one component (e.g., the power source 165) of the field system 100 to another (e.g., the electrical device 139 of a sub 148). Each power transfer link 187 may be sized (e.g., 12 gauge, 18 gauge, 4 gauge) in a manner suitable for the amount (e.g., 480V, 24V, 120V) and type (e.g., alternating current, direct current) of power transferred therethrough.

An electrical device 139 (also sometimes referred to herein as a subsurface electrical device 139) of a sub 148 is configured to perform a function in the wellbore 111. Examples of an electrical device 139 may include, but are not limited to, a valve (e.g., a safety valve, an inflow control valve, a lubricator valve, an isolation valve, an isolation barrier valve), a sensor device (e.g., similar to a sensor device 160 discussed below), and a motor (e.g., a motor for an electrical submersible pump (ESP)). In some cases, an electrical device 139 of a sub 148 operates in cycles, running for intervals of time. In some cases, a sensor device 160-2 may be used to measure one or more power parameters (e.g., voltage, current, VARs, instantaneous power (e.g., in kWs), power usage (e.g., in kWhs), inductance) associated with the operation of a subsurface electrical device 139.

The field system 100 also includes a Xmas tree 140 that is mounted at the entry point (e.g., atop a wellhead) of the wellbore 111. The Xmas tree 140 is a stack of vertical and/or horizontal valves, spools, pressure gauges, chokes, and/or other components installed as an assembly on the subsea wellhead. The Xmas tree 140 is configured to provide a controllable interface between the wellbore 111 and production facilities (e.g., via a subsea pipeline). The various valves of the Xmas tree 140 can be used for such purposes as testing, servicing, regulating, and/or choking the stream of produced subterranean resources coming up from the wellbore 111. In some cases, the Xmas tree 140 may include one or more of a number of other components, including but not limited to one or more power sources 165 and one or more sensor devices 160.

A power source 165 that is integrated with the Xmas tree 140 (or otherwise located near the entry point of the wellbore 111) is configured to provide power to one or more components of the field system 100 at and/or near the Xmas tree 140. For example, a power source 165 may provide power and/or control signals to one or more of the electrical devices 139 of one or more of the subs 148 in the wellbore 111 via power transfer links 187 and/or communication links 105 in the form of one or more electrical cables that are positioned in the annulus 192.

In some cases, a power source 165 obtains power from a power supply (e.g., AC mains, a generator) and manipulates (e.g., transforms, rectifies, inverts) that power to provide the manipulated power to one or more other components (e.g., an electrical device 139, a sensor device 160, a valve of the Xmas tree 140) of the field system 100, where the manipulated power is of a type (e.g., alternating current, direct current) and level (e.g., 12V, 24V, 120V) that may be used by the other components of the field system 100.

A power source 165 may include one or more of a number of single or multiple discrete components (e.g., transistor, diode, resistor, transformer) and/or a microprocessor. A power source 165 may include a printed circuit board, upon which the microprocessor and/or one or more discrete components are positioned. In addition, or in the alternative, a power source 165 may be a source of power in itself to provide signals to the other components of the field system 100. For example, a power source 165 may be or include an energy storage device (e.g., a battery). As another example, a power source 165 may be or include a turbine-generator set where the turbine rotates using tidal flows near the ground 108 in a subsea operation. As yet another example, a power source 165 may be or include a turbine-generator set where the turbine rotates using wind that blows above the ground 108.

In addition, the field system 100 includes an example subsurface electrical device monitoring system 145. The subsurface electrical device monitoring system 145 may include one or more of any of a number of components. Examples of such components may include one or more sensor devices 160 and one or more controllers 104. Most of the one or more sensor devices 160-1 (or at least the sensors thereof) are located in the wellbore 111 (e.g., in the annulus 192 (as in this case), in the cavity 196), while any remainder of the sensor devices 160-1 and the one or more controllers 104 are located above the ground 108. One or more of the controllers 104 and/or portions of the sensor devices 160-1 may be integrated with the Xmas tree 140.

Each sensor device 160 (e.g., sensor device 160-1, sensor device 160-2) of the field system 100 includes one or more sensors that measure one or more parameters (e.g., temperature, pressure, flow rate, humidity, depth, location, voltage, electrical current, electrical power, electrical usage, etc.). Examples of a sensor of a sensor device 160 may include, but are not limited to, a temperature sensor, a flow sensor, a pressure sensor, a gas spectrometer, a voltmeter, an ammeter, a gyroscope, a spectrograph, a gas chromatograph, and a camera. A sensor device 160 may be a stand-alone device or integrated with another component (e.g., a controller 104) of the field system 100.

A parameter measured by one or more sensor devices 160-1 of the subsurface electrical device monitoring system 145 may be associated with the temperature along a vertical section within the wellbore 111. In certain example embodiments, a sensor device 160-1 is or includes a distributed temperature sensing (DTS) fiber cable that is configured to measure multiple temperatures simultaneously along a vertical section within the wellbore 111. In some cases, the vertical section of the wellbore 111 covered by the sensor device 160-1 in the form of a DTS fiber cable includes the location of one or more of the electrical devices 139. For example, as shown in FIG. 1, the sensor device 160-1 in the form of a DTS fiber cable has a proximal end located at or near the ground 108 and a distal end located within the annulus 192 and extending to a depth in the wellbore 111 that exceeds the depth of the last (deepest) of the electrical devices 139 in the tubing string 177.

In such a case, the proximal end of the sensor device 160-1 in the form of a DTS fiber cable is communicably coupled to a controller 104 of the subsurface electrical device monitoring system 145. The one or more sensors of a sensor device 160-1 may measure temperatures continuously, at regular intervals (e.g., every 10 seconds, every minute, every hour), based on the occurrence of an event (e.g., during the operation of an electrical device 139), randomly, and/or based on some other factor.

In some cases, in addition, a parameter measured by a sensor device 160-2 may be associated with one or more of the electrical devices 139 integrated with the tubing string 177 in the wellbore 111. For example, a sensor device 160-2 may be configured to measure one or more power parameters (e.g., voltage, current, demand, usage, real power, imaginary power, inductance) associated with operation of one or more of the subsurface electrical devices 139. The one or more sensors of a sensor device 160-2 may measure temperatures continuously, at regular intervals (e.g., every 10 seconds, every minute, every hour), based on the occurrence of an event (e.g., during the operation of an electrical device 139), randomly, and/or based on some other factor.

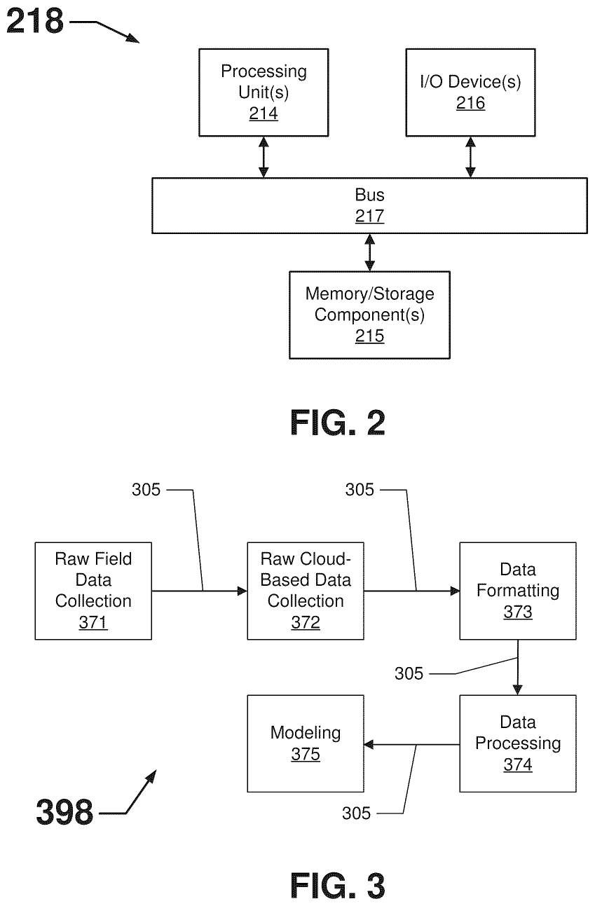

In some cases, a number of sensor devices 160, each measuring a different parameter, may be used in combination to determine and confirm whether a controller 104 should take a particular action (e.g., operate a valve, send a notification about the integrity of an electrical device 139). For example, a controller 104 may be configured to correlate the measurements made by sensor device 160-1 and second sensor device 160-2 by time. In such a case, the controller 104 may further be configured to generate a baseline of performance of the one or more electrical devices 139 over periods of time within which the subsurface electrical device 139 starts. When a sensor device 160 includes its own controller (or portions thereof), similar to a controller 104, then the sensor device 160 may be considered a type of computer device, as discussed below with respect to FIG. 2.

A user 151 may be any person that interacts, directly or indirectly, with a controller 104 and/or any other component of the field system 100, including any component of the example subsurface electrical device monitoring system 145. Examples of a user 151 may include, but are not limited to, a business owner, an engineer, a company representative, a geologist, a consultant, a drilling engineer, a contractor, and a manufacturer's representative. A user 151 may use one or more user systems 155, which may include a display (e.g., a GUI). A user system 155 of a user 151 may interact with (e.g., send data to, obtain data from) a controller 104 via an application interface and using the communication links 105. A user 151 may also interact directly with a controller 104 through a user interface (e.g., keyboard, mouse, touchscreen). Examples of a user system 155 may include, but are not limited to, a cell phone, a smart phone, a desktop computer, a laptop computer, a tablet, and a handheld electronic device.

The network manager 180 is a device or component that controls all or a portion (e.g., a communication network, a controller 104) of the field system 100 or portions thereof including one or more components of the subsurface electrical device monitoring system 145. The network manager 180 may be substantially similar to some or all of a controller 104, as described below. For example, the network manager 180 may include a controller that has one or more components and/or similar functionality to some or all of a controller 104. Alternatively, the network manager 180 may include one or more of a number of features in addition to, or altered from, the features of a controller 104. As described herein, control and/or communication with the network manager 180 may include communicating with one or more other components of the field system 100 (including one or more components of the subsurface electrical device monitoring system 145) and/or another system. In such a case, the network manager 180 may facilitate such control and/or communication. The network manager 180 may be called by other names, including but not limited to a master controller, a network controller, and an enterprise manager. The network manager 180 may be considered a type of computer device, as discussed below with respect to FIG. 2.

Interaction between each controller 104, the sensor devices 160, the users 151 (including any associated user systems 155), the network manager 180, and other components (e.g., the valves) of the field system 100, including other components of the subsurface electrical device monitoring system 145, may be conducted using communication links 105 and/or power transfer links 187.

A controller 104 of the field system 100 is configured to communicate with and in some cases control one or more of the other components (e.g., a sensor device 160, a valve, another controller 104) of the field system 100, including other components of the subsurface electrical device monitoring system 145. A controller 104 performs any of a number of functions that include, but are not limited to, obtaining and sending data, evaluating data, following protocols, running algorithms, and sending commands.

A controller 104 may include one or more of a number of components. For example, such components of a controller 104 may include, but are not limited to, a control engine, a correlation module, a baseline determination module, a sensor device performance module, an electrical device performance module, a communication module, a timer, a power module, a storage repository (e.g., including protocols, algorithms, stored data), a hardware processor, a memory, a transceiver, an application interface, and a security module. A controller 104 (or components thereof) may be located at or near the various components of the field system 100, including the subsurface electrical device monitoring system 145. In addition, or in the alternative, a controller 104 (or components thereof) may be located remotely from (e.g., in the cloud, at an office building) the various components of the field system 100, including the other components of the subsurface electrical device monitoring system 145.

When there are multiple controllers 104 (e.g., one controller 104 for one or more of the power sources 165, another controller 104 for the subsurface electrical device monitoring system 145), each controller 104 may operate independently of each other. Alternatively, two or more of the multiple controllers 104 may work cooperatively with each other. As yet another alternative, one of the controllers 104 may control some or all of one or more other controllers 104 in the field system 100 or portion thereof (e.g., the subsurface electrical device monitoring system 145). Each controller 104 may be considered a type of computer device, as discussed below with respect to FIG. 2.

As discussed above, one or more of the controllers 104 of the field system 100 may be part of the example subsurface electrical device monitoring system 145. In such a case, a controller 104 of the example subsurface electrical device monitoring system 145 may be configured to perform analysis (e.g., performance integrity analysis, temperature analysis, power analysis) on the electrical devices 139 and/or one or more other components (e.g., a sensor device 160-1) of the subsurface electrical device monitoring system 145. In this way, a controller 104 may be used, for example, to monitor the status of the electrical devices 139 and the example subsurface electrical device monitoring system 145 in real time.

The various components of the controller 104 (e.g., control engine, transceiver, communication module, storage repository) may be centrally located. In addition, or in the alternative, some of the components of the controller 104 may be located remotely from (e.g., in the cloud, at an office building, on site on the ground 108 near the wellbore 111, on a vessel floating in water above the wellbore 111) one or more of the other components of the controller 104.

The storage repository of a controller 104 may be a persistent storage device (or set of devices) that stores software and data used to assist the controller 104 in communicating with one or more other components of the field system 100 (including other components of the example subsurface electrical device monitoring system 145), such as the users 151 (including associated user systems 155), the network manager 180, the other controllers 104, the sensor devices 160, the power sources 165, and/or any other components of the field system 100, including other components of the subsurface electrical device monitoring system 145. In one or more example embodiments, the storage repository stores one or more protocols, one or more algorithms, and stored data.

Stored data of the storage repository of a controller 104 may be any data associated with the various equipment (e.g., an electrical device 139, a power source 165, a sensor device 160-1), including associated components, of the subsurface electrical device monitoring system 145, the user systems 155, the network manager 180, the other controllers 104, the sensor devices 160 outside the subsurface electrical device monitoring system 145, measurements made by the sensor devices 160, specifications of the sensor devices 160, threshold values, ranges of acceptable values, tables, results of previously run or calculated algorithms, updates to protocols and/or algorithms, user preferences, and/or any other suitable data. Such data may be any type of data, including but not limited to historical data, present data, and future data (e.g., forecasts). The stored data may be associated with some measurement of time derived, for example, from a timer of the controller 104.

The protocols of the storage repository of a controller 104 may be any procedures (e.g., a series of method steps) and/or other similar operational processes that the control engine of the controller 104 follows based on certain conditions at a point in time. The protocols may include any of a number of communication protocols that are used to send and/or obtain data between the controller 104 and other components of the field system 100, including other components of the subsurface electrical device monitoring system 145. Such protocols used for communication may be a time-synchronized protocol. Examples of such time-synchronized protocols may include, but are not limited to, a highway addressable remote transducer (HART) protocol, a wirelessHART protocol, and an International Society of Automation (ISA) 100 protocol. In this way, one or more of the protocols may provide a layer of security to the data transferred within the field system 100. Other protocols used for communication may be associated with the use of Wi-Fi, Zigbee, visible light communication (VLC), cellular networking, BLE, UWB, and Bluetooth.

The algorithms may be or include any formulas, mathematical models, forecasts, simulations, and/or other similar tools that a component (e.g., the control engine, the correlation module, the baseline determination module, the sensor device performance module, the electrical device performance module) of a controller 104 uses to reach a computational conclusion. For example, one or more algorithms may be used, in conjunction with one or more protocols and stored data, to assist a controller 104 to obtain measurements of a temperature parameter, made by one or more of the sensor devices 160-1, within the wellbore 111 and associated with the electrical devices 139. As another example, one or more algorithms may be used, in conjunction with one or more protocols and stored data, to assist a controller 104 to obtain measurements of one or more power parameters, made by one or more of the sensor devices 160-2, associated with the electrical devices 139.

As another example, one or more algorithms may be used, in conjunction with one or more protocols and stored data, to assist a controller 104 to process (e.g., filter, format, group, average) the measurements obtained from one or more of the various sensor devices 160 (e.g., sensor device 160-1, sensor device 160-2) to generate values associated with the measurements that may be used in subsequent analysis by the controller 104. As still another example, one or more algorithms may be used, in conjunction with one or more protocols and stored data, to assist a controller 104 to use the values associated with the measurements to generate a baseline of performance of one or more of the electrical devices over periods of time (e.g., all time, around when a subsurface electrical device 139 starts).

As another example, one or more algorithms may be used, in conjunction with one or more protocols and stored data, to assist a controller 104 to use the values associated with the measurements to evaluate the performance of one or more of the electrical devices 139 and/or one or more of the sensor devices 160 at a point in time or over time. As yet another example, one or more algorithms may be used, in conjunction with one or more protocols and stored data, to assist a controller 104 to compare the subsequent measurements made by a sensor device 160-1 against expected values derived from the baseline generated by the controller 104 for an electrical device 139. For example, such a comparison may include comparing the value of a temperature measurement to a range of acceptable values (e.g., stored data), where the range of acceptable values is established using the baseline.

As still another example, one or more algorithms may be used, in conjunction with one or more protocols and stored data, to assist a controller 104 to modify or establish an algorithm, a protocol, and or stored data (e.g., a threshold value, an expected value) based on differences between expected values and actual values. As yet another example, one or more algorithms may be used, in conjunction with one or more protocols and stored data, to assist a controller 104 to determine that a problem is developing with a subsurface electrical device 139 when a difference between one of the measurements and one of the expected values exceeds a threshold value.

As still another example, one or more algorithms may be used, in conjunction with one or more protocols and stored data, to assist a controller 104 to identify details (e.g., in terms of location on the electrical device 139 or associated sub 148, in terms of the nature of the problem (e.g., a developing electrical short, a grounding problem), an estimated amount of time before failure) with respect to a problem developing with an electrical device 139. As yet another example, one or more algorithms may be used, in conjunction with one or more protocols and stored data, to assist a controller 104 to generate and send a communication, in real time, to a user 151 (including an associated user system 155) about a problem with an electrical device 139.

Stored data, a protocol, and/or an algorithm of a controller 104 may be or be based on machine learning and/or an analytical model. For example, the control engine of a controller 104, through the use of stored data, one or more protocols and/or one or more algorithms, may implement machine learning as a way to evolve over time with new data and associated changes that may result from the new data. The control engine may use, for example, supervised learning, unsupervised learning, semi-supervised learning, and/or reinforcement learning, as those terms are known in the art of machine learning. In this case, these types of machine learning are effective with sufficient data (e.g., measurements from sensor devices 160) and use of stored data, algorithms, and/or protocols that automatically build mathematical models using sample data - also known as “training data”.

In this way, for example, a controller 104 may measure and interpret the measurements of one or more parameters (e.g., temperature parameters, power parameters) associated with an electrical device 139 and/or operation of the subsurface electrical device monitoring system 145 in order to establish baselines, compare subsequent data to baselines, adjust baselines, perform retroactive analysis, assess an electrical device 139 (including the performance integrity thereof), recommend a replacement of an electrical device 139, etc., using data and language elements native to the controller 104. Using this flexibility allowed by the learning protocols and/or algorithms, a controller 104 may scale to disparate vendor solutions and ‘build’ asset development optimization scenarios and recommendations. The learning protocols and/or algorithms may use or include large language models (LLM) to implement unique classification/semantic matching properties that may assist in the development of asset optimization by a controller 104.

The learning protocols and/or algorithms that may be used and trained by the control engine of a controller 104 may include, but are not limited to, instance-based learning algorithms, artificial neural network algorithms, deep learning algorithms, and ensemble algorithms. Instance-based learning algorithms typically build up a database of example data and compare new data to the database using a similarity measure in order to find the best match and make a prediction. For this reason, instance-based methods are also called winner-take-all methods and memory-based learning. Focus may be put on the representation of the stored instances and similarity measures used between instances. Instance-based algorithms may be computationally expensive for very large datasets since they save all training instances/data points and are sensitive to data noise.

Artificial neural networks may be fairly similar to the human brain. For example, artificial neural networks may be made up of artificial neurons, take in multiple inputs, and produce specific outputs. Artificial neural networks may be an enormous subfield comprised of a large number of neural network architectures and hundreds of algorithms and variations for different types of problems. Artificial neural networks may be biologically inspired computational simulations for certain specific tasks like clustering, classification, or pattern recognition.

Deep learning algorithms may be a modern update to artificial neural networks by building much larger and more complex neural networks. With deep learning, many methods may be applied to very large datasets. Various architectures may be applied for deep learning algorithms. Deep learning may have a high computational cost because much of its development requires advanced processing, storage hardware, and ML platforms/APIs.

Ensemble algorithm methods may be models composed of multiple weaker models that are independently trained and whose predictions are combined in some way to make the overall prediction. Various combination techniques (e.g., averaging, max voting, bagging/bootstrapping (sampling subsets of original complete dataset), boosting) may be applied. Unlike other standard ensemble methods where models are trained in isolation, the boosting technique may employ an iterative approach, training models in succession, with each new model being trained to correct the errors made by the previous ones. Models may be added sequentially until no further improvements may be made.

Examples of a storage repository of a controller 104 may include, but are not limited to, a database (or a number of databases), a file system, cloud-based storage, a hard drive, flash memory, some other form of solid-state data storage, or any suitable combination thereof. The storage repository of a controller 104 may be located on multiple physical machines, each storing all or a portion of the protocols, the algorithms, and/or the stored data according to some example embodiments. Each storage unit or device may be physically located in the same or in a different geographic location.

A controller 104 of the subsurface electrical device monitoring system 145 is configured to identify anomalous behavior of an electrical device 139 (e.g., an ESP) leading to the eventual failure through the collection, tracking, and interpretation of thermal data associated with the electrical device 139. In such cases, the controller 104 may track and identify localized heating after an electrical device 139 is turned on and/or turned off. The timing of the localized heating after an electrical device 139 may also be tracked. When an electrical device 139 is first put into service, the initial heating occurs long after (e.g., hours) the initial start to almost immediately after (e.g., minutes) the initial start.

A controller 104 of the subsurface electrical device monitoring system 145 is configured to anticipate anomalies in the operation of a subsurface electrical device 139, based on real time thermal data, and generate alerts and warnings. In this way, a controller 104 may detect anomalous thermal activity and use the time between the start of the electrical device 139 and the thermal anomaly as a proxy for severeness of the defect in the subsurface electrical device 139. Example embodiments may be configured to model the thermal behavior, which is currently not done in the art. Example embodiments may be configured to adopt machine learning methods to “learn” the relationship between time and severeness of the performance issue, based on thermal data and associated anomalies, of a subsurface electrical device 139. In some cases, example embodiments may be used to observe slow strain (e.g., a low frequency component) relating to the performance of a subsurface electrical device 139.

In one or more example embodiments, a controller 104 includes functionality to communicate with the users 151 (including associated user systems 155), the other controllers 104, the sensor devices 160, the network manager 180, and any other components in the field system 100 (including other components of the subsurface electrical device monitoring system 145). More specifically, a controller 104 may be configured to send information to and/or obtains information from the storage repository of the controller 104 in order to communicate with the users 151 (including associated user systems 155), the other controllers 104, the sensor devices 160, the network manager 180, and any other components of the field system 100 (including other components of the subsurface electrical device monitoring system 145).

A controller 104 may generate and process data associated with control, communication, and/or other signals sent to and obtained from the users 151 (including associated user systems 155), the other controllers 104, the sensor devices 160, the network manager 180, and any other components of the field system 100, including other components of the subsurface electrical device monitoring system 145. In certain embodiments, a controller 104 may communicate with one or more components of a system external to the field system 100.

The timer of a controller 104 may track clock time, intervals of time, an amount of time, and/or any other measure of time. The timer of a controller 104 may also count the number of occurrences of an event, whether with or without respect to time. The timer of a controller 104 may be able to track multiple time measurements and/or count multiple occurrences concurrently. The timer of a controller 104 may track time periods based on a measurement obtained from a sensor device 160, based on an instruction obtained from a user 151, based on an instruction programmed in the software for the controller 104, based on some other condition (e.g., the occurrence of an event) or from some other component, or from any combination thereof. In certain example embodiments, the timer of a controller 104 may provide a time stamp for each packet of data obtained from another component (e.g., a sensor device 160) of the example field system 100, including the example subsurface electrical device monitoring system 145.

A user 151 (including an associated user system 155), the other controllers 104, the sensor devices 160, the network manager 180, and the other components of the field system 100, including other components of the subsurface electrical device monitoring system 145, may interact with a controller 104 using an application interface of the controller 104. Examples of an application interface of a controller 104 may be or include, but are not limited to, an application programming interface, a web service, a data protocol adapter, some other hardware and/or software, or any suitable combination thereof. Similarly, the user systems 155 of the users 151, the other controllers 104, the sensor devices 160, the network manager 180, and/or the other components of the field system 100, including other components of the subsurface electrical device monitoring system 145, may include an interface (similar to the application interface of the controller 104) to obtain data from and send data to the controller 104 in certain example embodiments.

FIG. 2 shows a block diagram of a computing device 218 according to certain example embodiments. Specifically, FIG. 2 illustrates one embodiment of a computing device 218 that implements one or more of the various techniques described herein, and which is representative, in whole or in part, of the elements described herein pursuant to certain example embodiments. For example, a controller 104 (including components thereof, such as a control engine, a hardware processor, a storage repository, a power module, and a transceiver) may be considered a computing device 218. Computing device 218 is one example of a computing device and is not intended to suggest any limitation as to scope of use or functionality of the computing device and/or its possible architectures. Neither should the computing device 218 be interpreted as having any dependency or requirement relating to any one or combination of components illustrated in the example computing device 218.

The computing device 218 includes one or more processors or processing units 214, one or more memory/storage components 215, one or more input/output (I/O) devices 216, and a bus 217 that allows the various components and devices to communicate with one another. The bus 217 represents one or more of any of several types of bus structures, including a memory bus or memory controller, a peripheral bus, an accelerated graphics port, and a processor or local bus using any of a variety of bus architectures. The bus 217 includes wired and/or wireless buses.

The memory/storage component 215 represents one or more computer storage media. The memory/storage component 215 includes volatile media (such as random access memory (RAM)) and/or nonvolatile media (such as read only memory (ROM), flash memory, optical disks, magnetic disks, and so forth). The memory/storage component 215 includes fixed media (e.g., RAM, ROM, a fixed hard drive, etc.) as well as removable media (e.g., a Flash memory drive, a removable hard drive, an optical disk, and so forth).

One or more I/O devices 216 allow a user 151 to enter commands and information to the computing device 218, and also allow information to be presented to the user 151 and/or other components or devices. Examples of input devices 216 include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques is stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 218 (also sometimes called a computer system herein) is connected to a network (not shown) (e.g., a LAN, a WAN such as the Internet, cloud, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer device 218 includes at least the minimal processing, input, and/or output means necessary to practice one or more embodiments.

Further, those skilled in the art will appreciate that one or more elements of the aforementioned computer device 218 is located at a remote location and connected to the other elements over a network in certain example embodiments. Further, one or more embodiments are implemented on a distributed system having one or more nodes, where each portion of the implementation (e.g., the subsurface electrical device monitoring system 145) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

FIG. 3 shows an example of a general workflow 398 of the subsurface electrical device monitoring system 145 according to certain example embodiments. Referring to the description above with respect to FIGS. 1 and 2, the general workflow 398 of FIG. 3 starts with raw field data collection 371, where raw data (e.g., temperature measurements, power parameter measurements) is obtained by a portion of a controller 104 from one or more of the sensor devices 160, including sensor device 160-1. In some cases, the controller 104 may obtain the raw data from the sensor devices 160 in real time relative to when the measurements are taken using one or more communication links (e.g., similar to the communication links 105 discussed above).

The general workflow 398 may then proceed to cloud-based raw data collection 372, where the raw data may then be obtained by a cloud-based portion of the controller 104. In some cases, the cloud-based portion of the controller 104 may obtain the raw data from the site-based portion of the controller 104 in real time relative to when the measurements are taken using one or more communication links 305 (e.g., similar to the communication links 105 discussed above). The general workflow 398 may then proceed to data formatting 373, where the raw data may then be obtained by a data formatting portion of the controller 104 to generate formatted data. In some cases, the data formatting portion of the controller 104 may obtain the raw data from the cloud-based portion of the controller 104 in real time relative to when the raw data is obtained using one or more communication links 305 (e.g., similar to the communication links 105 discussed above). In some cases, the data formatting 373 portion of the controller 104 is also cloud-based.

The general workflow 398 may then proceed to data processing 374, where the formatted data may then be obtained by a data processing portion of the controller 104 to generate processed data. In some cases, the data processing portion of the controller 104 may obtain the formatted data from the data formatting portion of the controller 104 in real time relative to when the formatted data is obtained using one or more communication links 305 (e.g., similar to the communication links 105 discussed above). In some cases, the data processing 374 portion of the controller 104 is also cloud-based.

The general workflow 398 may then proceed to modeling 375, where the processed data may then be obtained by a modeling portion of the controller 104 to generate an output. In some cases, the modeling portion of the controller 104 may obtain the processed data from the data processing portion of the controller 104 in real time relative to when the processed data is obtained using one or more communication links 305 (e.g., similar to the communication links 105 discussed above). In some cases, the modeling 375 portion of the controller 104 is also cloud-based. The modeling 375 portion of the controller may utilize machine learning, as discussed above.

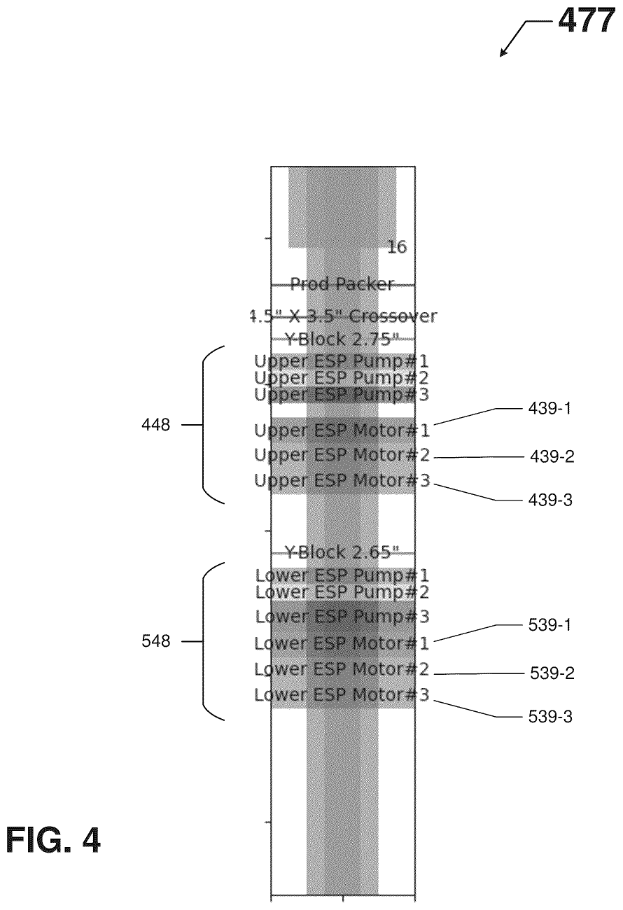

FIG. 4 shows part of a tubing string 477 that includes multiple electrical devices whose performance is monitored by a subsurface electrical device monitoring system according to certain example embodiments. Referring to the description above with respect to FIGS. 1 through 3, the part of the tubing string 477 of FIG. 4 includes two subs, each in the form of or including an ESP. Sub 448 is located higher up in the tubing string 477 and includes three pumps located above three motors. In this case, each motor is considered an electrical device 439. Electrical device 439-1 is located at the top of the stack of motors (just below the pumps) of the ESP, followed by electrical device 439-2, followed by electrical device 439-3. In alternative embodiments, all three motors of the sub 448 may be considered a single electrical device 439.

Sub 548 is located below sub 448 in the tubing string 477 and also includes three pumps located above three motors. In this case, each motor is considered an electrical device 539. Electrical device 539-1 is located at the top of the stack of motors (just below the pumps) of the ESP, followed by electrical device 539-2, followed by electrical device 539-3. In alternative embodiments, all three motors of the sub 548 may be considered a single electrical device 539.

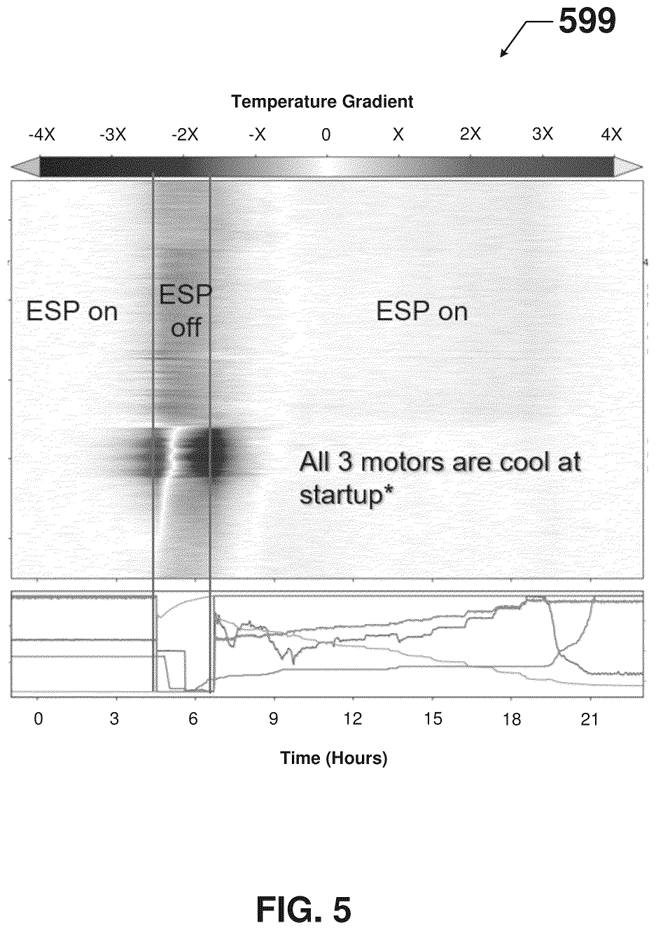

FIGS. 5 through 8 show graphical representations of evaluation of the electrical devices 439 and the electrical devices 539 of FIG. 4 by an example subsurface electrical device monitoring system (e.g., subsurface electrical device monitoring system 145) according to certain example embodiments. Referring to the description above with respect to FIGS. 1 through 4, the graphical representation 599 of FIG. 5 shows data relative to the performance of the six electrical devices (electrical device 439-1, electrical device 439-2, electrical device 439-3, electrical device 539-1, electrical device 539-2, and electrical device 539-3) of FIG. 4 located within a wellbore (e.g., wellbore 111). The graphical representation 599 of FIG. 5 shows a period of time when the two ESPs are put into initial service. The graphical representation 599 has two sections stacked vertically.

The upper section of the graphical representation 599 of FIG. 5 shows the temperature gradient, as generated by a controller (e.g., a controller 104) using measurements made by a sensor device (similar to a sensor device 160-1) in the form of a DTS fiber cable. The vertical axis of the upper section of the graphical representation 599 is in terms of measured depth (e.g., in feet) of the wellbore, and the horizontal axis of the upper section of the graphical representation 599 is in terms of time (in hours). The scale for the temperature gradient is displayed along the top of the upper section of the graphical representation 599.

The upper section of the graphical representation 599 shows that the temperature gradients for the electrical devices 439 of the upper sub 448 are different than the temperature gradients for the electrical devices 539 of the lower sub 548 (located approximately ⅔ from the top of the upper section of the graphical representation 599). Specifically, the temperature gradients for the electrical devices 439 of the upper sub 448 cool off almost immediately and uniformly when the electrical devices 439 are turned off and heat up uniformly to steady state after about two hours when the electrical devices 439 are turned on. By contrast, the temperature gradients for the electrical devices 439 of the upper sub 448 are not uniform, generally stay elevated for about 30 minutes after being turned off, and generally take about two hours after being turned on from a prolonged off period before reaching an elevated steady state.

The differences in the temperature gradients between the electrical devices 439 of sub 448 and the electrical devices 539 of sub 548 may be due to differences in electrical devices (e.g., motor size, motor capacity, manufacturer). Alternatively, the differences in the temperature gradients between the electrical devices 439 of sub 448 and the electrical devices 539 of sub 548 may be due to a performance issue with one or more of the electrical devices 539 of sub 548.

The lower section of the graphical representation 599 of FIG. 5 shows measurements of other parameters (e.g., electrical voltage, electric current, pressure in the wellbore, position of a check valve) associated with the ESPs and/or wellbore conditions made by other sensor devices (e.g., similar to sensor devices 160-2) over the same time period. These measurements in the lower section of the graphical representation 599 may be used to help the controller 104 determine when certain events (e.g., an electrical device 439 starting, an electrical device 539 stopping) occur. The measurements used to form both sections of the graphical representation 599 of FIG. 5 may be used to help the controller (e.g., controller 104) of the subsurface electrical device monitoring system 145 form a baseline for each of the electrical devices 439 and each of the electrical devices 539.

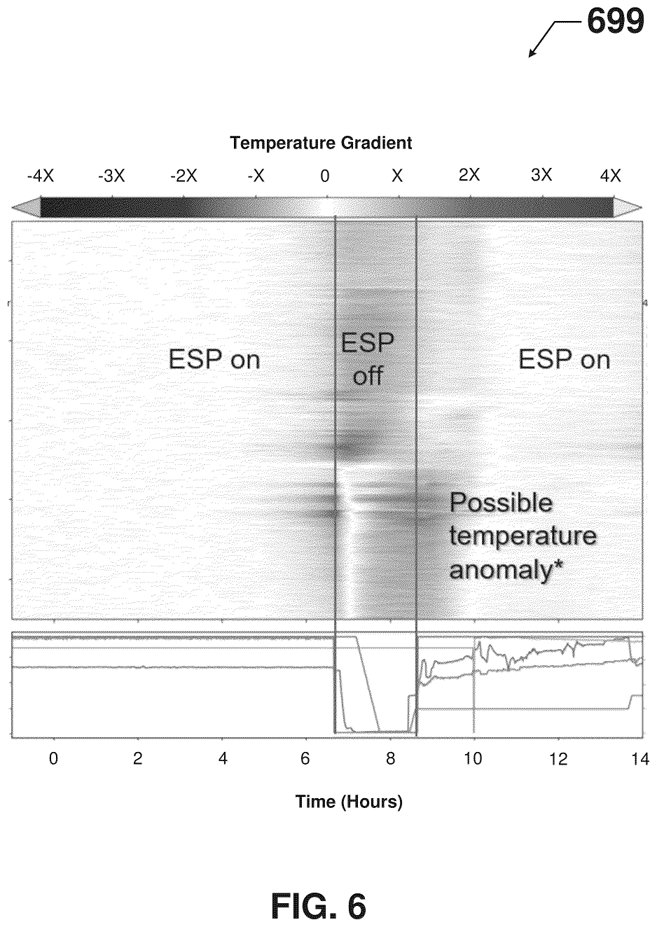

The graphical representation 699 of FIG. 6 shows data relative to the performance of the electrical devices 439 and the electrical devices 539 from FIG. 5. The graphical representation 699 of FIG. 6 shows a period of time about 6 months later than the period of time shown in FIG. 5. The graphical representation 699 has two sections stacked vertically. The upper section of the graphical representation 699 of FIG. 6 shows the temperature gradient, as generated by a controller (e.g., a controller 104) using measurements made by a sensor device (similar to a sensor device 160-1) in the form of a DTS fiber cable. The vertical axis of the upper section of the graphical representation 699 is in terms of measured depth (e.g., in feet) of the wellbore, and the horizontal axis of the upper section of the graphical representation 699 is in terms of time (in hours).

The scale for the temperature gradient is displayed along the top of the upper section of the graphical representation 699. The upper section of the graphical representation 699 shows that the differences in the temperature gradients for the electrical devices 439 of the upper sub 448 are greater than the temperature gradients for the electrical devices 539 of the lower sub 548 (located approximately ⅔ from the top of the upper section of the graphical representation 699) since the period of time captured in FIG. 5. Specifically, the temperature gradients for the electrical devices 439 of the upper sub 448 in FIG. 6 continue to cool off almost immediately and uniformly when the electrical devices 439 are turned off and heat up uniformly to steady state after about two hours when the electrical devices 439 are turned on. By contrast, the temperature gradients for the electrical devices 439 of the upper sub 448 in FIG. 6 are even less uniform, generally continues to stay elevated for about 30 minutes after being turned off, and generally continues to take about two hours after being turned on from a prolonged off period before reaching an elevated steady state. These differences may be the indication of a developing performance issue with the electrical devices 539, particularly electrical device 539-3.

The lower section of the graphical representation 699 of FIG. 6 shows measurements of other parameters (e.g., electrical voltage, electric current, pressure in the wellbore, position of a check valve) associated with the ESPs and/or wellbore conditions made by other sensor devices (e.g., similar to sensor devices 160-2) over the same time period. The measurements used to form both sections of the graphical representation 699 of FIG. 6 may be used to help the controller (e.g., controller 104) of the subsurface electrical device monitoring system 145 continue to track one or more performance trends of each of the electrical devices 439 and each of the electrical devices 539.

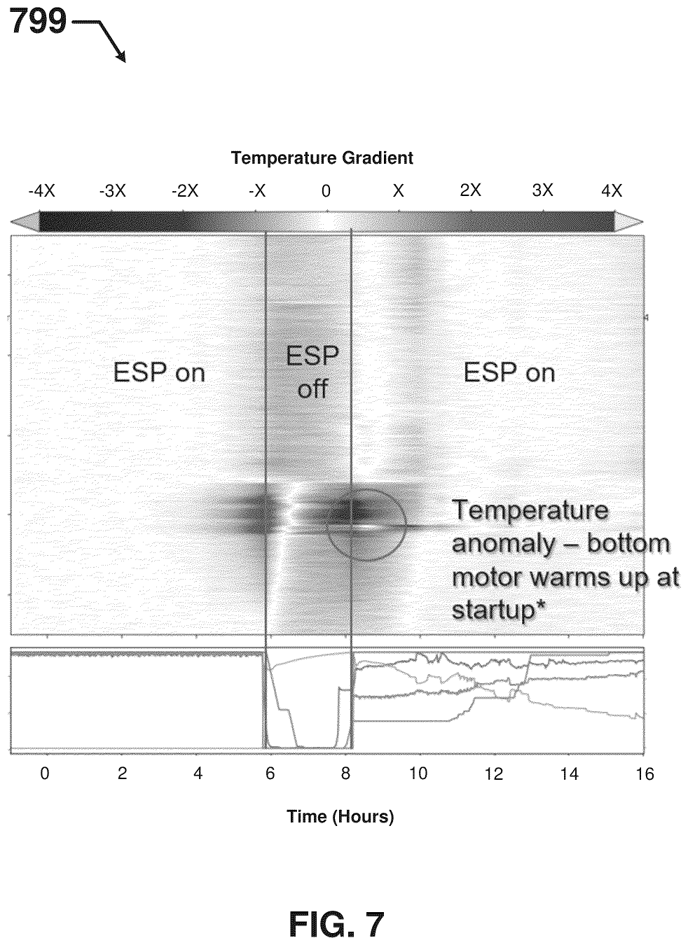

The graphical representation 799 of FIG. 7 shows data relative to the performance of the electrical devices 439 and the electrical devices 539 from FIGS. 5 and 6. The graphical representation 799 of FIG. 7 shows a period of time about one month later than the period of time shown in FIG. 6. The graphical representation 799 has two sections stacked vertically. The upper section of the graphical representation 799 of FIG. 7 shows the temperature gradient, as generated by a controller (e.g., a controller 104) using measurements made by a sensor device (similar to a sensor device 160-1) in the form of a DTS fiber cable. The vertical axis of the upper section of the graphical representation 799 is in terms of measured depth (e.g., in feet) of the wellbore, and the horizontal axis of the upper section of the graphical representation 799 is in terms of time (in hours).

The scale for the temperature gradient is displayed along the top of the upper section of the graphical representation 799. The upper section of the graphical representation 799 shows that the differences in the temperature gradients for the electrical devices 439 of the upper sub 448 are greater than the temperature gradients for the electrical devices 539 of the lower sub 548 (located approximately ⅔ from the top of the upper section of the graphical representation 799) since the period of time captured in FIG. 6. Specifically, the temperature gradients for the electrical devices 439 of the upper sub 448 in FIG. 7 continue to cool off almost immediately and uniformly when the electrical devices 439 are turned off and heat up uniformly to steady state after about two hours when the electrical devices 439 are turned on. By contrast, the temperature gradients for the electrical devices 439 of the upper sub 448 in FIG. 7 are even less uniform, generally now stays elevated for about an hour after being turned off, and generally continues to take about two hours after being turned on from a prolonged off period before reaching an elevated steady state.

The lower section of the graphical representation 799 of FIG. 7 shows measurements of other parameters (e.g., electrical voltage, electric current, pressure in the wellbore, position of a check valve) associated with the ESPs and/or wellbore conditions made by other sensor devices (e.g., similar to sensor devices 160-2) over the same time period. The measurements used to form both sections of the graphical representation 799 of FIG. 7 may be used to help the controller (e.g., controller 104) of the subsurface electrical device monitoring system 145 continue to track one or more performance trends of the electrical devices 439 and each of the electrical devices 539.

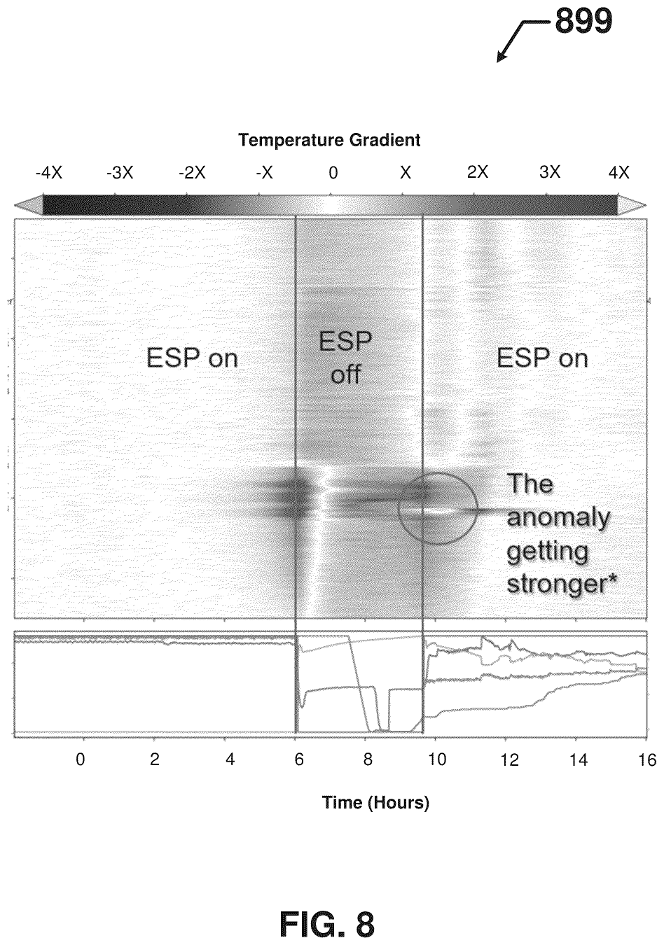

The graphical representation 899 of FIG. 8 shows data relative to the performance of the electrical devices 439 and the electrical devices 539 from FIGS. 5 through 7. The graphical representation 899 of FIG. 8 shows a period of time about one month later than the period of time shown in FIG. 7. The graphical representation 899 has two sections stacked vertically. The upper section of the graphical representation 899 of FIG. 8 shows the temperature gradient, as generated by a controller (e.g., a controller 104) using measurements made by a sensor device (similar to a sensor device 160-1) in the form of a DTS fiber cable. The vertical axis of the upper section of the graphical representation 899 is in terms of measured depth (e.g., in feet) of the wellbore, and the horizontal axis of the upper section of the graphical representation 899 is in terms of time (in hours).

The scale for the temperature gradient is displayed along the top of the upper section of the graphical representation 899. The upper section of the graphical representation 899 shows that the differences in the temperature gradients for the electrical devices 439 of the upper sub 448 are greater than the temperature gradients for the electrical devices 539 of the lower sub 548 (located approximately ⅔ from the top of the upper section of the graphical representation 899) since the period of time captured in FIG. 7. Specifically, the temperature gradients for the electrical devices 439 of the upper sub 448 in FIG. 8 continue to cool off almost immediately and uniformly when the electrical devices 439 are turned off and heat up uniformly to steady state after about two hours when the electrical devices 439 are turned on.

By contrast, the temperature gradients for the electrical devices 439 of the upper sub 448 in FIG. 8 are even less uniform, generally continues to stay elevated for about an hour after being turned off, and generally continues to take about two hours after being turned on from a prolonged off period before reaching an elevated steady state. However, as indicated in FIG. 8, the break in the distribution pattern of the temperature gradients that coincide with the electrical devices 539 at shut down and start up is more pronounced relative to what was observed in FIG. 7. These differences provide an indication that the electrical devices 39, and in particular electrical device 539-1, are having performance problems that are progressively worsening. In this case, the example subsurface electrical device monitoring system 145 predicts that electrical device 539-3 fails in about a month from the time captured in FIG. 8.

The lower section of the graphical representation 899 of FIG. 8 shows measurements of other parameters (e.g., electrical voltage, electric current, pressure in the wellbore, position of a check valve) associated with the ESPs and/or wellbore conditions made by other sensor devices (e.g., similar to sensor devices 160-2) over the same time period. The measurements used to form both sections of the graphical representation 899 of FIG. 8 may be used to help the controller (e.g., controller 104) of the subsurface electrical device monitoring system 145 continue to track one or more performance trends of the electrical devices 439 and each of the electrical devices 539.

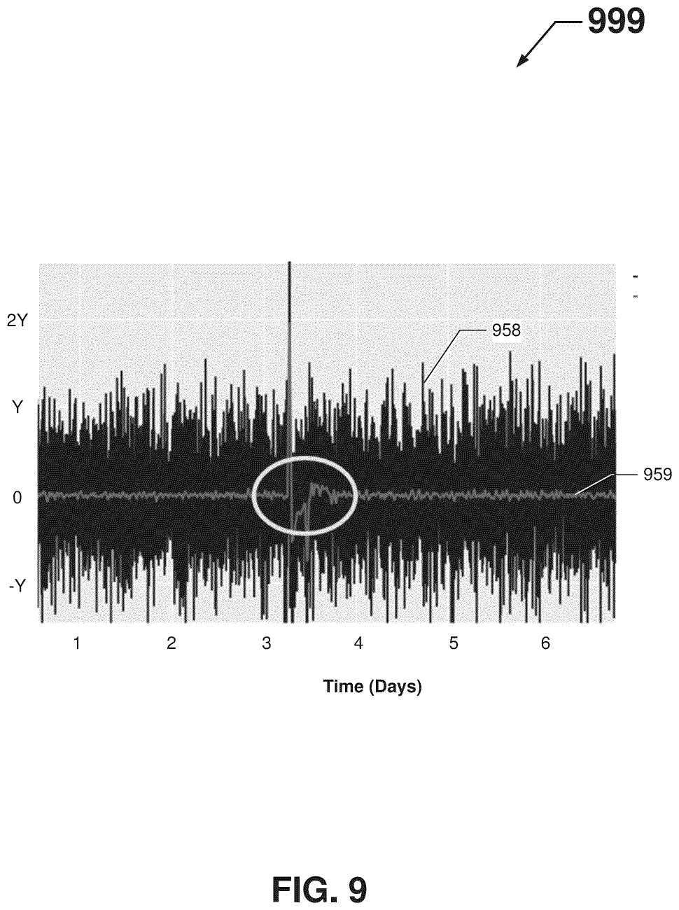

FIG. 9 shows a graphical representation 999 of training data generated by the subsurface electrical device monitoring system 145 according to certain example embodiments. Referring to the description above with respect to FIGS. 1 through 8, the graphical representation 999 of FIG. 9 plots temperature gradients along the vertical axis and time (in minutes) along the horizontal axis. Plot 958 is a collection of raw temperature measurements of an electrical device (e.g., electrical device 139) in a wellbore (e.g., wellbore 111) by a sensor device (e.g., sensor device 160-1) over time.

Plot 959 of FIG. 9 is a collection of processed (e.g., filtered, averaged) versions of the raw temperature measurements over the same period of time. The plot 959 is generated by a controller 104 of the example subsurface electrical device monitoring system 145. The circled area on the graphical representation 999 shows an anomaly that occurs in the temperature data, representing a possible performance problem in the operation of the electrical device 139. The time period captured in FIG. 9 may represent when the electrical device 139 is just coming online, and so the controller 104 may use this data in generating a baseline with respect to the performance of the electrical device 139.

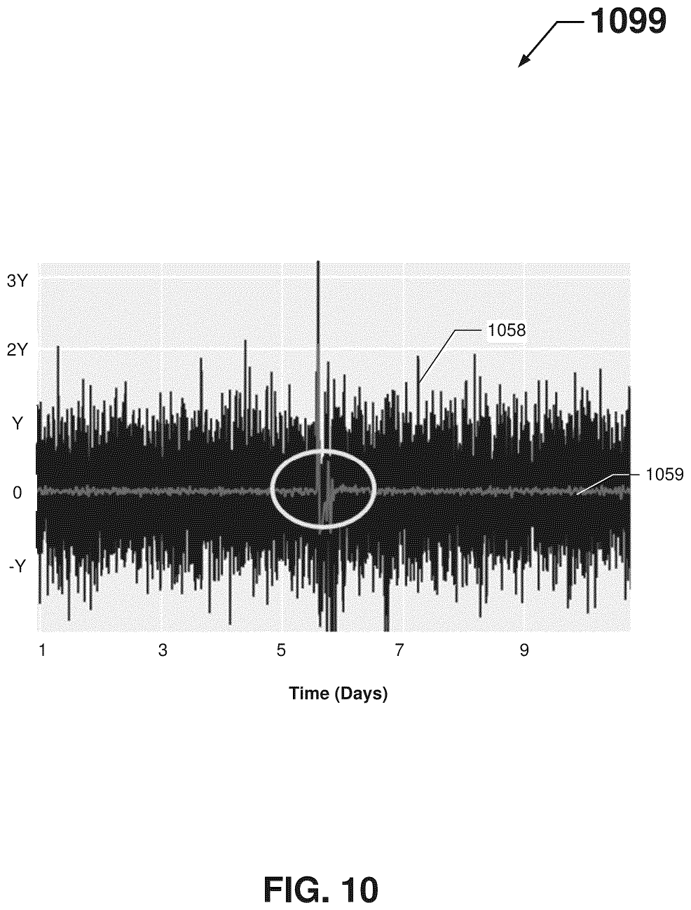

FIG. 10 shows a graphical representation 1099 of testing data generated by the subsurface electrical device monitoring system 145 according to certain example embodiments. Referring to the description above with respect to FIGS. 1 through 9, the graphical representation 1099 of FIG. 10 plots temperature gradients along the vertical axis and time (in minutes) along the horizontal axis. Plot 1058 is a collection of raw temperature measurements of an electrical device (e.g., electrical device 139) in a wellbore (e.g., wellbore 111) by a sensor device (e.g., sensor device 160-1) over time.

Plot 1059 of FIG. 10 is a collection of processed (e.g., filtered, averaged) versions of the raw temperature measurements over the same period of time. The plot 1059 is generated by a controller 104 of the example subsurface electrical device monitoring system 145. The circled area on the graphical representation 1099 shows an anomaly that occurs in the temperature data, representing a possible performance problem in the operation of the electrical device 139. The time period captured in FIG. 10 may represent when the electrical device 139 has been operating for an extended period of time, and so the controller 104 may compare this data to a baseline (e.g., as from FIG. 9) to evaluate the performance of the electrical device 139.

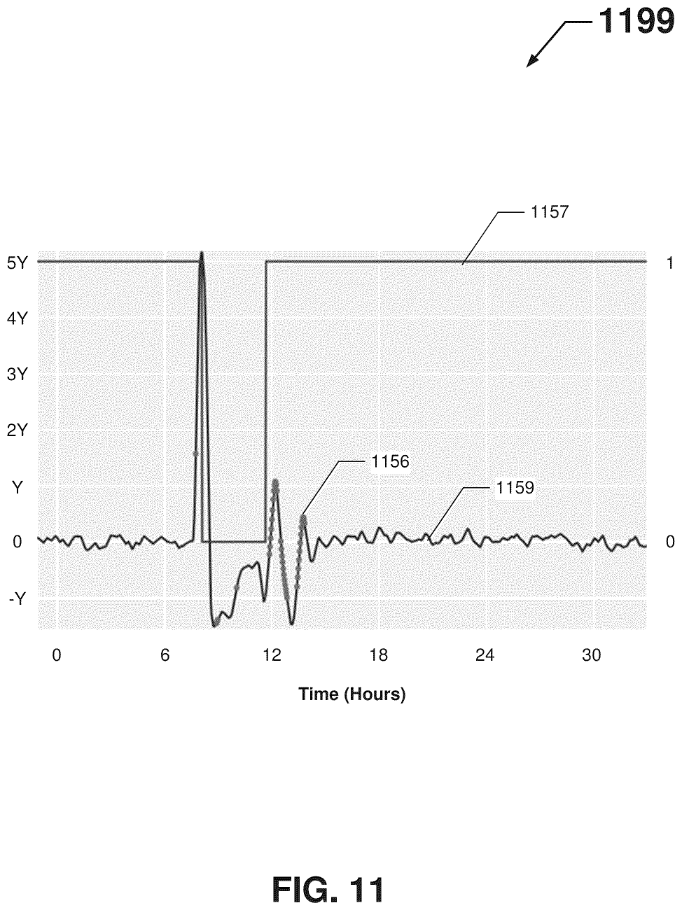

FIG. 11 shows a graphical representation 1199 of predicting the performance integrity of an electrical device 139 by the subsurface electrical device monitoring system 145 according to certain example embodiments. Referring to the description above with respect to FIGS. 1 through 10, the graphical representation 1199 of FIG. 11 plots temperature gradients along the left vertical axis, an ON state (represented by the number 1) and an OFF state (represented by the number 0), and time (in minutes) along the horizontal axis. Plot 1159 of FIG. 11 is a collection of processed (e.g., filtered, averaged) versions of the raw temperature measurements over a period of time. The plot 1159 is generated by a controller 104 of the example subsurface electrical device monitoring system 145.

Plot 1157 corresponds to the right vertical axis and shows when the electrical device 139 is receiving power (the ON state) and when the electrical device 139 is not receiving power (the OFF state). Plot 1156 corresponds to anomalies that are detected by the controller 104 of the example subsurface electrical device monitoring system 145 when the plot 1159 is compared to a baseline in light of when the electrical device 139 is being powered up and/or powered down. The controller 104 may then analyze these anomalies and determine, for example, whether a failure of the electrical device 139 is occurring, the cause of the failure, the amount of time before there is a complete failure, etc.

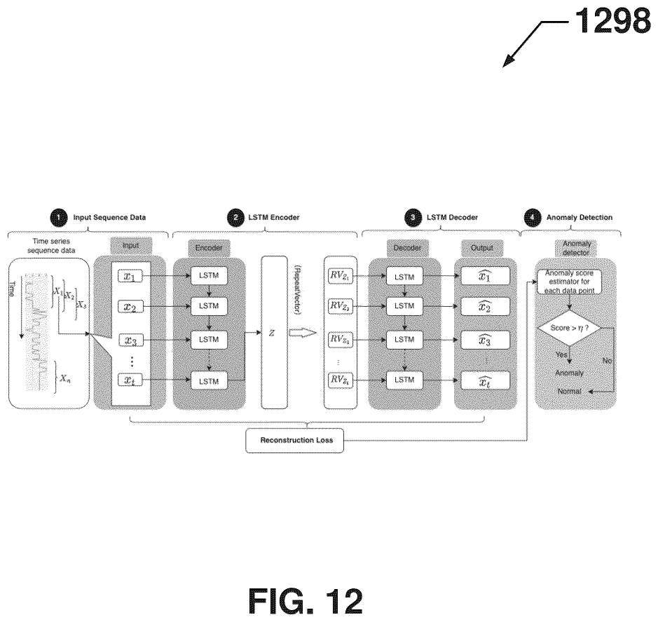

FIG. 12 shows a flow diagram 1298 of a methodology used by the subsurface electrical device monitoring system 145 according to certain example embodiments. Referring to the description above with respect to FIGS. 1 through 11, the flow diagram 1298 of FIG. 12 begins at step 1, where input sequence data in the form of time-series sequence data is obtained, processed, and organized. In step 2, the time sequence data becomes an input for a long short-term memory (LSTM) encoder, which encodes the time sequence data. The resulting encoded time sequence data generated by the LSTM encoder is then delivered in step 3 to a LSTM decoder, which decodes the data. In parallel, a reconstruction loss module uses the raw time sequence data, the encoded data, and the decoded data as inputs to an anomaly module in step 4. The anomaly module is configured to identify anomalies in the data, which correspond to a performance issue with an electrical device 139.

The various modules in each step of the flow diagram 1298 may be part of a controller (e.g., controller 104) of an example subsurface electrical device monitoring system 145. The LSTM memory and related modules are one type of recurrent neural network that may be designed to support sequential data, as in this case. The methodology captured in the flow diagram 1298 of FIG. 12 is designed for unsupervised learning. In such a case, the model may be trained on the “normal” (non-anomalous) data, learn to reconstruct the data, and identify anomalies based on differences between reconstructed data and original data.

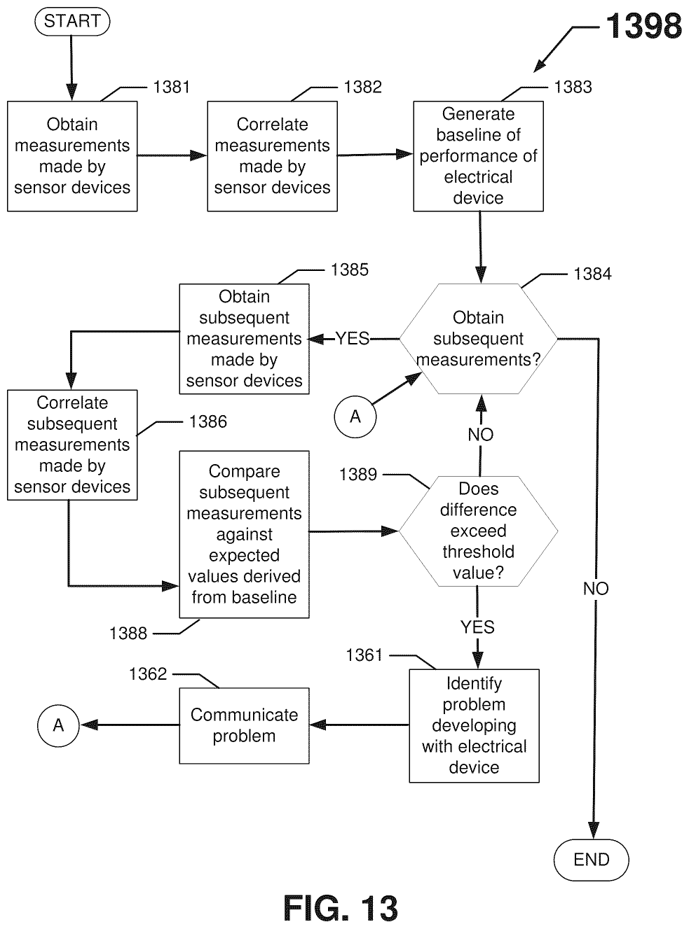

FIG. 13 shows a flowchart 1398 of a method for monitoring the integrity of a subsurface electrical device 135 according to certain example embodiments. While the various steps in this flowchart 1398 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order.

In addition, a person of ordinary skill in the art will appreciate that additional steps not shown in FIG. 13 may be included in performing this method. Accordingly, the specific arrangement of steps should not be construed as limiting the scope. Further, a particular computing device, such as a controller 104 or other type of computing device discussed above, may be used to perform or facilitate performance of one or more of the steps (or portions thereof) for the method shown in FIG. 13 in certain example embodiments. Any of the functions (or portions thereof) performed below by a controller 104 may involve the use of one or more protocols, one or more algorithms, and/or stored data stored in a storage repository. In some cases, one or more of the various steps in the method of FIG. 13 can be performed automatically, as by the controller 104 of the example subsurface electrical device monitoring system 145.

The method shown in FIG. 13 is merely an example that may be performed by using an example subsurface electrical device monitoring system 145 described herein. In other words, systems for monitoring the integrity of a subsurface electrical device 139 may perform other functions using other methods in addition to and/or aside from those shown in FIG. 13. The method shown in the flowchart 1398 of FIG. 13 begins at the START step and proceeds to step 1381, where measurements made by sensor devices 160 (e.g., sensor devices 160-1, sensor devices 160-2) are obtained. The measurements may be of temperatures, power parameters, and/or any other type of parameter associated with one or more subsurface electrical devices 139 and their operation. In some cases, once the measurements are obtained, they are formatted, averaged, organized, and/or otherwise processed.

In step 1382, the measurements made by the sensor devices 160 are correlated. The measurements may be correlated, for example, by time and/or by the activity (e.g., turning on, turning off) of one or more subsurface electrical devices 139. In step 1383, a baseline of one or more of the subsurface electrical devices 139 is generated using the correlated data. In step 1384, a determination is made as to whether additional (e.g., subsequent) measurements may be obtained. If subsequent measurements may be obtained, the process proceeds to step 1385. If subsequent measurements may not be obtained, the process proceeds to the END step. In step 1385, subsequent measurements made by sensor devices 160 (e.g., sensor devices 160-1, sensor devices 160-2) are obtained.

In step 1386, the subsequent measurements made by the sensor devices 160 are correlated. In step 1388, the subsequent measurements are compared against expected values derived from the baseline. Om step 1389, a determination is made as to whether a difference between a subsequent measurement and an expected value exceeds a threshold value. If a difference between a subsequent measurement and an expected value exceeds a threshold value, the process proceeds to step 1361. If a difference between a subsequent measurement and an expected value does not exceed a threshold value, the process reverts to step 1384. In step 1361, a problem that is developing with the subsurface electrical device 139 is identified. In step 1362, the problem that is identified is communicated (e.g., to a user 151 or an associated user system 155). When step 1362 is complete, the process reverts to step 1384.

Example embodiments can be used to monitor the operation of one or more subsurface electrical devices using measurements of temperature, power parameters, and/or other parameters associated with the operation of the subsurface electrical devices. Example embodiments may also be used to generate and maintain a baseline of the operational behavior of the subsurface electrical devices and use the baseline to determine, in real time, if a subsurface electrical device has an emerging problem. Example embodiments may include predictive capabilities (e.g., estimate an amount of time before total failure) and analytic capabilities (e.g., the precise location and/or cause of a developing failure). The sensor devices used with example embodiments may be or include DTS fiber cable. Example embodiments also provide a number of other benefits. Such other benefits can include, but are not limited to, improved useful life of the electrical devices, more reliable subterranean field operations, time savings, cost savings, and compliance with applicable industry standards and regulations.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A subsurface electrical device monitoring system comprising:
a first sensor device disposed within a wellbore adjacent to a subsurface electrical device, wherein the first sensor device is configured to measure a temperature;
a second sensor device that is configured to measure a power parameter associated with the subsurface electrical device;
a controller communicably coupled to the first sensor device and the second sensor device, wherein the controller is configured to:
obtain measurements made by the first sensor device and the second sensor device;
correlate the measurements made by the first sensor device and the second sensor device by time;
generate a baseline of performance of the electrical device over periods of time within which the subsurface electrical device starts;
obtain subsequent measurements made by the first sensor device and the second sensor device;
correlate the subsequent measurements made by the first sensor device and the second sensor device by time;
compare the subsequent measurements made by the first sensor device against expected values derived from the baseline; and
determine that a problem is developing with the subsurface electrical device when a difference between one of the subsequent measurements and one of the expected values exceeds a threshold value.

2. The subsurface electrical device monitoring system of claim 1, wherein the controller compares the subsequent measurements against the expected values and determines that the problem is developing in real time.

3. The subsurface electrical device monitoring system of claim 1, wherein the subsurface electrical device comprises an electrical submersible pump.

4. The subsurface electrical device monitoring system of claim 1, wherein the subsurface electrical device comprises a valve.

5. The subsurface electrical device monitoring system of claim 1, wherein the first sensor device comprises a distributed temperature sensing (DTS) fiber cable that is configured to measure a plurality of temperatures along a vertical section within the wellbore, and wherein the vertical section includes a location of the subsurface electrical device.

6. A method for monitoring an integrity of a subsurface electrical device, the method comprising:
obtaining, by a controller, measurements made by a first sensor device and a second sensor device, wherein the first sensor device is disposed within a wellbore adjacent to the subsurface electrical device, wherein the first sensor device is configured to measure a temperature, and wherein the second sensor device is configured to measure a power parameter associated with the subsurface electrical device;
correlating the measurements made by the first sensor device and the second sensor device by time;
generating a baseline of performance of the electrical device over periods of time within which the subsurface electrical device starts;
obtaining subsequent measurements made by the first sensor device and the second sensor device;
correlating the subsequent measurements made by the first sensor device and the second sensor device by time;
comparing the subsequent measurements made by the first sensor device against expected values derived from the baseline; and
determining that a problem is developing with the subsurface electrical device when a difference between one of the subsequent measurements and one of the expected values exceeds a threshold value.

7. The method of claim 6, further comprising:
sending a communication, in real time, to a user about the problem.
